(19) United States
(12) Patent Application Publication
(10) Pub. No.: US 2016/0040783 A1
(43) Pub. Date: Feb. 11, 2016

(54) FLAT GASKET

(71) Applicant: ElringKlinger AG, Dettingen (DE)

(72) Inventor: Wilhelm Kullen, Huelben (DE)

(73) Assignee: ElringKlinger AG

(21) Appl. No.: 14/919,129

(22) Filed: Oct. 21, 2015

Related U.S. Application Data
(63) Continuation of application No. PCT/EP2014/055548, filed on Mar. 19, 2014.

(30) Foreign Application Priority Data
Apr. 22, 2013 (DE) 102013104068.3

(51) Int. Cl. F16J 15/08; F01N 13/08

(52) U.S. Cl. CPC F16J 15/0818; F16J 15/0887; F01N 13/08; F16J 2015/0868

(57) ABSTRACT

Metallic flat gasket for installation between sealing surfaces, which face each other, of components conducting hot gas, which are connected to one another, the metallic flat gasket including a gasket plate which is compressed when the gasket is installed and which has at least two metallic gasket layers arranged one above the other and several hot gas through-openings, the gasket plate having between at least two adjacent hot gas through-openings a gasket plate web which separates the hot gas through-openings from one another. The gasket is configured such that the sum of the material thicknesses of the gasket layers in the region of a gasket plate web is less than in other gasket plate regions bordering on the hot gas through-openings, although the gasket also has in the region of this web at least one gasket layer.

### CROSS-REFERENCE TO RELATED APPLICATIONS

The present application is a continuation of international application number PCT/EP2014/055548 filed on Mar. 19, 2014 and claims the benefit of German application number 102013104068.3 filed on Apr. 22, 2013, the entire specification of both being incorporated herein by reference.

### FIELD OF DISCLOSURE

The invention relates to a metallic flat gasket for installation between sealing surfaces, which face each other, of components conducting hot gas, which are connected to one another, the metallic flat gasket comprising a gasket plate which is compressed when the gasket is installed and which has several metallic gasket layers arranged one above the other and several hot gas through-openings, the gasket plate having between at least two adjacent hot gas through-openings a gasket plate web which, in a plan view of the gasket plate, separates the hot gas through-openings from one another.

In particular, the invention relates to gaskets for the exhaust gas region of an internal combustion engine, preferably flange gaskets on an exhaust gas turbocharger, such as gaskets between an exhaust manifold and an exhaust gas turbocharger or between the chargers of a multistage exhaust gas turbocharger system. The invention specifically relates to a flat gasket for the connection of a twin-scroll turbocharger.

### BACKGROUND

A metallic flat gasket will be understood by the gasket expert as also meaning gaskets which are not purely metallic but consist only predominantly of metallic materials. In particular, such a flat gasket can contain at least one gasket layer which is provided on one or both sides over the entire surface or partially with a non-metallic coating, for example, a coating which reduces friction or wear.

In sealing systems with known flat gaskets of the kind defined at the outset between sealing surfaces, facing each other, of metallic components conducting hot gas, in which the components are drawn towards each other and pressed with their sealing surfaces against the flat gasket by means of assembly screws extending through the components and the flat gasket or other tensioning elements, the problem described hereinbelow arises and has proven particularly serious especially in sealing systems located in the exhaust gas region of internal combustion engines.

For the flows of hot gas, the components have adjacent hot gas channels which open into the component sealing surfaces and form sealing surface openings there, which communicate with one another via the hot gas through-openings of the flat gasket—in general, the sealing surface openings of the components lying one behind the other in the direction of flow of a flow of gas and the hot gas through-opening of the flat gasket lying therebetween are identical in shape and size and lie congruently one over the other. Each component has between adjacent hot gas channels, in each case, a separating wall which in section (taken along a plane containing the longitudinal channel axes) is of web-like configuration at least in a component region bordering on the sealing surface openings. Therefore, in the following, these separating walls will be referred to as component webs. These component webs are configured such that when the flat gasket is installed they should be pressed in a gas-tight manner against the flat gasket with their end face regions facing one another, more specifically, against at least one gasket plate web lying between two component webs.

When operation starts, the inner component webs located between adjacent hot gas channels heat up quicker and to a stronger extent during operation than peripheral component regions in which the component sealing surfaces are also pressed against the flat gasket, but the operating temperature of these peripheral component regions is significantly lower than that of the inner component webs located between adjacent hot gas channels, and so the axial thermal expansion of these component webs (expansion perpendicular to the gasket plate plane of the flat gasket) is significantly greater than that of the peripheral component regions which are only subjected on one side to heat from the hot gas channels, whereas each inner component web is subjected to heat by the hot gases on both of its sides. Consequently, during operation, the pressing forces occurring between the component sealing surfaces and the flat gasket and oriented perpendicularly to the gasket plate plane in the region of a gasket plate web and of the inner component webs accommodating the gasket plate web between them are much greater than in other gasket plate regions bordering on the hot gas through-openings, and, at the same time, the degree of tension in the peripheral component regions and outside of the entirety of the hot gas through-openings of the gasket plate is significantly reduced in comparison with the degree of tension before operation is started.

At the very high temperatures prevailing during operation in the hot gas regions, in particular, in exhaust gas regions, the material of the components is plasticized under high pressing forces, and so the above-described end face regions of the inner component webs that are pressed against the flat gasket undergo plastic deformation, with the result that after termination of operation, when the sealing system cools down, gaps occur between a gasket plate web and the inner component webs accommodating the gasket plate web between them, and also after resumption of operation, adjacent hot gas channels are no longer separated from one another with respect to leakage of gas to the extent that was the case prior to initial operation of the sealing system.

In addition to the aforesaid phenomenon, conventional sealing systems also have the following disadvantages: Owing to the above-described high pressing forces occurring in the region of a gasket plate web, the flat gasket may also become damaged in the region of a gasket plate web, and, in addition, there is the risk of overloading the tensioning elements of the sealing system located outside of the entirety of the hot gas channels, which are usually assembly screws, but, for example, may also be a so-called V-bond.

In order to avoid damage to the components, the flat gasket and/or the tensioning elements of the sealing system owing to the above-described thermal expansions, which differ from region to region, sealing systems have already been in use, in which, in the region of the so-called sealing gap between the component sealing surfaces, which is to be sealed by the flat gasket, a separation, even if only gas-tight to some extent, of adjacent flows of hot gas was dispensed with from the start, and so the components can expand freely in the axial direction between their hot gas channels, and an inner gap in the sealing gap of the sealing system between adjacent hot gas channels is tolerated. However, since adjacent flows of gas are only very inadequately separated from one another in such a sealing system, this has a negative effect on the functioning of an exhaust gas turbocharger, for example, in the exhaust gas tract of an internal combustion engine.

### SUMMARY OF THE INVENTION

The object underlying the invention was to propose a flat gasket for a sealing system of the kind defined at the outset, which in the sealing gap enables a relatively good separation with respect to gas of adjacent flows of hot gas, but also eliminates or at least minimizes the risk of damage to the components and/or to the flat gasket while the sealing system is in operation.

In accordance with the invention, this object is accomplished with a multilayered metallic flat gasket of the kind mentioned at the outset, in which the sum of the material thicknesses of the gasket layers, arranged one above the other, of the gasket plate, in the region of a gasket plate web or possibly several or all of the gasket plate webs, is less than in the other gasket plate regions bordering on the hot gas through-openings of the gasket plate, but the gasket plate is also formed by at least one gasket layer in the region of this gasket plate web.

A flat gasket configured in accordance with the above-described basic principle of the invention allows the components accommodating the flat gasket between them to expand in the axial direction on either side of a gasket plate web and, therefore, in the regions of their inner component webs during operation of the sealing system such that neither these component webs are plastically deformed nor the flat gasket is damaged in the region of its gasket plate web or its gasket plate webs and/or the tensioning elements of the sealing system are overloaded. Nevertheless, a flat gasket in accordance with the invention can be configured such that with it adjacent flows of hot gas in the sealing gap between the component sealing surfaces can be separated from one another to the extent required for good functioning of the entire system, in particular, for the functioning of an exhaust gas turbocharger device, as this only requires a coordination of the size of the reduction in some regions of the sum of the material thicknesses of the gasket layers of the gasket plate arranged one above the other in the region of a gasket plate web and the axial thermal expansion of the inner component webs, which results in no or at least no appreciable plastic deformation of the component webs, on the one hand, and a sealing capacity of the flat gasket between two adjacent flows of hot gas in the sealing gap, which is sufficient for the functioning of the entire system, on the other hand.

The basic principle of the invention defined hereinabove is preferably implemented with one of the two following measures or a combination of these measures, a prerequisite of each of these measures being a multilayered flat gasket in accordance with the invention, in which at least one of the gasket layers has, in the region of at least one gasket plate web, a gasket layer web which, in a plan view of the gasket plate, separates the two hot gas through-openings adjacent to the gasket plate web from each other.

In accordance with a first type of implementation, one gasket layer (in a gasket with three or more gasket layers possibly also a further gasket layer) has no web in the region of at least one gasket plate web, in order to reduce in the region of this gasket plate web the sum of the material thicknesses of the gasket layers.

In accordance with a second type of implementation, at least one gasket layer (in a gasket with three or more gasket layers possibly also a further gasket layer) has such a varying material thickness that the gasket layer in the region of at least one gasket layer web of this gasket layer has a material thickness which is smaller than its material thickness in the other regions of this gasket layer bordering on the hot gas through-openings, and so the sum of the material thicknesses of the gasket layers in the region of this gasket layer web is reduced. The material thickness of this gasket layer web need not be the same throughout, but only smaller than in other regions of this gasket layer, which border on the hot gas through-openings.

In preferred embodiments of the flat gasket in accordance with the invention, the sum of the material thicknesses of the gasket layers in the region of a gasket plate web is, in particular, less by 25 to 75% than in other gasket plate regions bordering on the hot gas through-openings. A reduction in thickness of the gasket plate in the upper range of the aforementioned range relates to flat gaskets in accordance with the invention with a so-called stopper layer or a so-called carrier layer, which are usually produced from substantially thicker metal sheets than so-called functional layers; in accordance with the invention, in the region of at least one gasket plate web the stopper or carrier layer is then locally omitted, and so it has no web there.

As a precaution, it is pointed out that (in a plan view of the gasket plate or the pertinent gasket layer) a gasket plate web or a gasket layer web need not be of the same width and/or straight throughout but, for example, in its lengthwise end regions may be broader than between these and/or be curved or have an angular configuration.

The following is also to be noted in connection with the above-described first type of implementation: In a multilayered flat gasket in accordance with the invention, the gasket layers have layer openings for passage of the hot gases corresponding to the hot gas through-openings of the gasket plate, with the exception of the gasket layer (possibly the gasket layers) which serves to locally reduce the material thickness of the gasket plate—in this gasket layer two layer openings otherwise separated from each other by a gasket layer web form a single opening.

Finally, mention is made of the fact that in a flat gasket in accordance with the invention with a gasket plate comprising more than two gasket layers, a gasket layer configured in accordance with the invention may form an outer layer or an inner layer of the gasket plate.

In preferred embodiments of the flat gasket in accordance with the invention, at least one of the gasket layers, in particular, an outer layer or each outer layer of the gasket plate, is provided with a sealing bead completely enclosing the entirety of the hot gas through-openings, in a plan view of the gasket plate, which may be a so-called full bead or a so-called half bead. Optimum sealing of the sealing gap to be sealed by the flat gasket to prevent leakage of hot gas from the sealing system is thereby achieved.

The invention does relate to metallic flat gaskets, but at the outset it was already pointed out that a flat gasket to which the invention relates need not be purely metallic, but, for example, may be provided with a nonmetallic coating. A flat gasket in accordance with the invention configured for the hot gas region, namely the exhaust gas region of an internal combustion engine, may contain at least one gasket layer which is provided on one or both sides over the entire surface or partially with a coating consisting of boron nitride particles and a resin as bonding agent. A flat gasket in accordance with the invention configured for the exhaust gas region of an internal combustion engine is, however, characterized by being free of elastomeric and/or thermosetting sealing materials.

In particular, a flat gasket in accordance with the invention configured for the exhaust gas region of an internal combustion engine is characterized, if it has at least one coating, in that the at least one coating material is a material which at the operating temperatures of the flat gasket of mostly more than 500° C. and, in particular, temperatures ranging from more than 600° C. to 900° C., preferably to 1,200° C., ensures a coating which is still effective, in particular, a coating which reduces friction and/or wear or a coating with a certain, even if not perfect, sealing effect.

A flat gasket in accordance with the invention is advantageously configured such that the gasket plate web forms one piece with the gasket plate.

Above all, in a flat gasket in accordance with the invention configured for the exhaust gas region of an internal combustion engine, the gasket plate web should border directly on the adjacent hot gas through-openings, which, in particular, means that the gasket plate web does not serve as holder for separately produced metallic sealing elements which enclose the hot gas through-openings.

In accordance with the basic concept underlying the present invention, the sum of the material thicknesses of the gasket layers in the region of a gasket plate web is less than in other gasket plate regions bordering on the hot gas through-openings. In this connection, the following applies to preferred embodiments of the flat gasket in accordance with the invention, either individually or in any combination.

In preferred embodiments, the sum of the material thicknesses of the gasket layers is to be understood as the sum of the metallic material thicknesses, possibly also including the thickness of a metallic coating or several metallic coatings—coatings made of sintered bronze are, for example, used for flat gaskets to be used in the exhaust gas region.

In particularly advantageous embodiments of the invention, the sum of the metal material thicknesses of the gasket layers in the region of a gasket plate web and, in particular, over the entire length of the gasket plate web is less than in all other gasket plate regions bordering on the hot gas through-openings.

In view of a further development of the flat gasket in accordance with the invention explained hereinbelow, it is pointed out that at least in preferred embodiments of the flat gasket in accordance with the invention, the metal material thickness of a gasket plate web is the material thickness of at least one web region which, when the flat gasket is installed, is clamped between component surfaces parallel to the gasket plate plane. In the event that at least one gasket layer has differences in thickness in the region of a gasket plate web in section transverse to the longitudinal direction of the web, the sum of the metal material thicknesses of the gasket layers in the region of a gasket plate web is to be understood as the maximum sum of the metal material thicknesses of the gasket layers in the region of the gasket plate web.

Furthermore, in preferred embodiments of the invention, the metal material thickness of a gasket layer and, in particular, each gasket layer in the region of at least one gasket layer web formed by the gasket layer is to be understood as the maximum metal material thickness of the gasket layer in the region of the gasket layer web.

With a view to further improving the separation of the flows of gas conducted in adjacent hot gas channels of the components in the region of the sealing gap from one another, the following is recommended.

In a flat gasket with the above-described first type of implementation of the present invention, a gasket layer web, preferably each gasket layer web, is provided with at least one elongate gas blocking element extending in the longitudinal direction of the gasket layer web. The gasket blocking element protrudes beyond the gasket layer comprising the gasket layer web and is preferably configured such that it projects over at least one of the two main surfaces of this gasket layer transversely (not necessarily perpendicularly) to the gasket plate plane such that, when the flat gasket is installed, it lies, in particular, over its entire length against a component web, thereby sealing as well as possible. In preferred embodiments of the flat gasket in accordance with the invention, at least one further gasket layer is provided adjacent to the first gasket layer provided with the gasket layer web. The further gasket layer has no web in the region of the gasket layer web of the first gasket layer, and the gas blocking element passes through the further gasket layer when the flat gasket is installed and compressed.

In a flat gasket in accordance with the invention with one or more such gas blocking elements, which protrude beyond the gasket layer web, in view of the problem solved by the present invention, it is self-evident that the material thickness of such a gas blocking element is not to be taken into account in the sum of the material thicknesses of the gasket layers.

In particularly advantageous embodiments of the flat gasket in accordance with the invention, the gasket layer web has a substantially L-shaped, V-shaped, U-shaped or Z-shaped cross section in the region of the at least one gas blocking element—with a V-shaped or U-shaped cross section, the gasket layer web forms two gas blocking elements projecting in the same direction, with a Z-shaped cross section, two gas blocking elements projecting in opposite directions; the gasket layer web provided with at least one gas blocking element can then preferably be configured such that when the flat gasket is installed, the gas blocking element is, in particular, elastically deflected and pretensioned transversely to its longitudinal direction and parallel to the gasket plate plane, in order to further improve its sealing capacity.

In flat gaskets with which the invention is implemented in the above-described second way, i.e., with a gasket layer web of reduced thickness, it may be recommendable to provide this gasket layer web with at least one elongate bead extending in the longitudinal direction of the gasket layer web and forming, in the compressed state, i.e., when the flat gasket is installed, a gas blocking element.

If the gasket layer provided with the at least one gas blocking element comprises a sealing bead completely enclosing the entirety of the hot gas through-openings, this gas blocking element ends at its two lengthwise ends at a distance from this sealing bead because it might not be possible, depending on the type of bead, for the gas blocking element to lead into the sealing bead. It has, however, been shown that even then the gas blocking element separates flows of hot gas adjacent to one another in the sealing gap from one another at least such that gas exchange between the flows of hot gas is hindered to a sufficiently strong extent.

However, also when a gasket layer web which is not of reduced thickness has a substantially U-shaped cross section in the region of the gas blocking elements formed by it, it may be recommendable to provide the base of the U-shaped cross section with a bead which projects outwards over this base in order to then strongly hinder gas exchange between adjacent flows of hot gas in the sealing gap with this bead when the flat gasket is installed. In particular, this bead has only a minimal height in comparison with a conventional sealing bead, i.e., it is a so-called microbead.

The invention also relates to a sealing system with a metallic flat gasket, which is clamped between sealing surfaces, which face each other, of components which are connected to one another, each of the components containing at least two hot gas channels, which extend adjacently to each other and open into its component sealing surface, and between which a separating wall separating the hot gas channels from each other is provided in the component, the separating wall forming a component web ending at the component sealing surface and extending in the hot gas channel over a length which is greater and preferably many times greater than the length of the component web measured in the component sealing surface, the flat gasket comprising a gasket plate with at least two metallic gasket layers arranged one above the other and several hot gas through-openings via which the hot gas channels of the components communicate with one another, and the gasket plate having between at least two adjacent hot gas through-openings a gasket plate web which separates the hot gas through-openings from one another and is arranged, in particular, clamped between two component webs of the components accommodating the flat gasket between them.

In accordance with the invention, such a sealing system is characterized in that the sum of the material thicknesses of the gasket layers in the region of a gasket plate web is less than in other gasket plate regions bordering on the hot gas through-openings, and in that the gasket plate also has in the region of this gasket plate web at least one gasket layer.

The above statements relating to the configuration of flat gaskets in accordance with the invention also apply to the flat gasket of such a sealing system.

### BRIEF DESCRIPTION OF THE DRAWINGS

Further features, advantages and details of the invention are given in the appended claims and/or the attached drawings and the following description of these drawings in which, in addition to the prior art, preferred embodiments of the invention are represented; in the drawings:

FIG. 1 shows a section through a conventional sealing system with two components accommodating between them a two-layer metallic flat gasket;

FIG. 2 shows a plan view of a metallic flat gasket which could be installed in the sealing system in accordance with FIG. 1;

FIGS. 3A and 3B show sections taken along line 3-3 in FIG. 2 through two embodiments of this flat gasket;

FIG. 4 shows an isometric representation of a preferred embodiment of a flat gasket in accordance with the invention;

FIG. 5 shows a plan view of the flat gasket shown in FIG. 4;

FIGS. 6 and 7 show sections taken along lines 6-6 and 7-7 in FIG. 5;

FIG. 8 shows a second embodiment of the flat gasket in accordance with the invention, similar to the flat gasket in accordance with FIGS. 4 to 7, in a section corresponding to line 8-8 in FIG. 5;

FIGS. 8A, 8B and 9 show representations, corresponding to FIG. 8, of a third to fifth embodiment;

FIG. 9A shows a sectional representation of the gasket layer web shown in FIG. 7 or in FIG. 9, in which a component web engages; and

FIGS. 10, 10A and 11 show representations, again corresponding to FIG. 8, of a sixth, seventh and eighth embodiment.

### DETAILED DESCRIPTION OF THE INVENTION

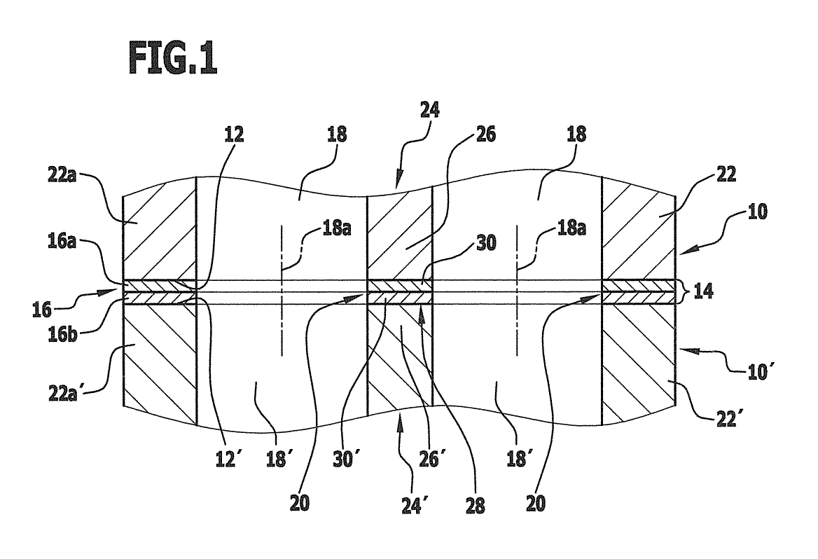

FIG. 1 shows adjacent regions of two components 10 and 10′, one of which may, for example, be an exhaust manifold of a reciprocating-piston internal combustion engine, and the other one of which may, for example, be a flange of an exhaust gas turbocharger. The two components have flat and parallel component sealing surfaces 12 and 12′ which, in the assembled sealing system, include between them and delimit a so-called sealing gap 14, in which a gasket plate 16, clamped between the component sealing surfaces 12, 12′, of a metallic flat gasket is arranged, which comprises, for example, two metallic gasket layers 16a and 16b. The components 10, 10′ are usually cast metal parts.

Formed in each of the components 10, 10′ are several adjacent hot gas channels 18, 18′ which, in the aforementioned example, serve to conduct flows of hot exhaust gas from the internal combustion engine, open into the component sealing surfaces 12, 12′ and communicate with one another via hot gas through-openings 20 formed in the gasket plate 16.

The openings, lying in the component sealing surfaces 12, 12′ of two hot gas channels 18, 18′, communicating with each other, and the hot gas through-opening 20, lying between these, of the gasket plate 16 are, as usual, preferably each of the same size and the same shape and lie congruently one over the other. At least in regions bordering on the sealing gap 14, the hot gas channels 18, 18′ have axes 18a. The axes of two hot gas channels 18, 18′ communicating with each other coincide and extend transversely (not necessarily perpendicularly) to the plane of the sealing gap 14 or the gasket plate 16.

For the sake of simplicity, FIG. 1 shows components 10, 10′ with, in each case, only two adjacent hot gas channels 18, 18′. The components may, however, also contain a larger number of hot gas channels.

Each of the components 10, 10′ has peripheral component regions which are formed at and in the vicinity of the component sealing surfaces 12, 12′ of outer walls 22 and 22a of the component 10 and of outer walls 22′ and 22a′ of the component 10′, respectively. Furthermore, adjacent hot gas channels 18, 18′ at and in the vicinity of the component sealing surfaces 12, 12′ are separated from one another by separating walls 24, 24′ of the two components 10, 10′. The separating wall 24 at and in the immediate vicinity of the component sealing surface 12 forms a component web 26, and, in a corresponding manner, the separating wall 24′ forms a component web 26′. When the sealing system is cold and not yet in operation, the end face of the component web 26 and the end faces of the outer walls 22 and 22a lie in one plane, more specifically, in the plane of the component sealing surface 12, and the same applies accordingly to the end faces of the component web 26′, the outer wall 22′ and the outer wall 22a′ and also to the component sealing surface 12′.

Between adjacent hot gas through-openings 20 the gasket layers 16a, 16b have gasket layer webs 30, 30′ and the gasket plate 16 has a gasket plate web 28 formed by the gasket layer webs, which, seen from above or below in accordance with FIG. 1, separates from one another adjacent hot gas through-openings 20 and, during operation, adjacent flows of hot gas.

When the sealing system is in operation, the outer walls 22, 22a, 22′ and 22a′ are only subjected to heat on one side, namely by the hot gases coming from the hot gas channels 18, 18′, whereas the component webs 26, 26′ are subjected to heat on both sides, namely coming from two hot gas channels 18, in each case, and so the component webs 26, 26′ heat up quicker when operation starts and also get hotter than the outer walls 22, 22a, 22′, 22a′ during operation. The component webs 26, 26′ expand correspondingly quicker and to a correspondingly greater extent in the axial direction (i.e. in the direction of the axes 18a) downwards and upwards, respectively, in accordance with FIG. 1, which results in the pressing forces between the component webs 26, 26′ and the gasket plate web 28 being much greater than the pressing forces between the outer walls 22, 22′, 22a, 22a′ and the regions of the gasket plate 16 arranged between these. Owing to these great pressing forces between the component webs 26, 26′ and the gasket plate web 28, the materials of the particularly hot component webs 26, 26′ become plastically deformed and the gasket plate 16 may possibly become deformed or damaged in some other way in the region of the gasket plate web 28, and so after termination of operation and cooling-down of the sealing system, permanent gaps occur between the end faces of the component webs 26, 26′ and the gasket plate web 28, through which a considerable exchange of gas can take place between adjacent hot gas channels 18 and 18′, respectively, and not only when operation is resumed, but also when the sealing system is in continuous operation.

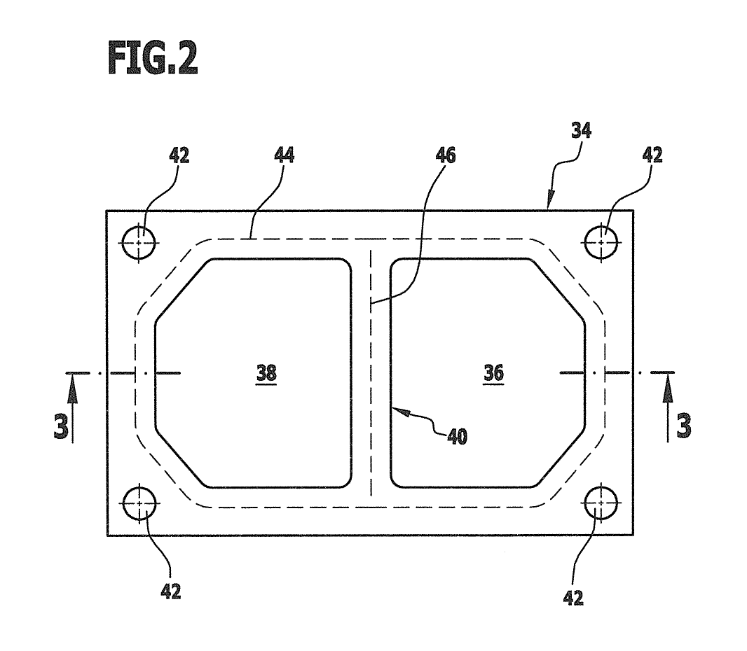

FIG. 2 shows a plan view of a metallic flat gasket, which could be the flat gasket used in the sealing system in accordance with FIG. 1, but also a flat gasket in accordance with the present invention, which will be discussed hereinbelow.

The flat gasket shown in FIG. 2 has a gasket plate 34 comprising two or more metallic gasket layers arranged one above the other (which is not shown in FIG. 2). Two adjacent hot gas through-openings 36 and 38, which are separated from each other by a gasket plate web 40, are formed in the gasket plate 34. Furthermore, the gasket plate 34 has screw holes 42 for the passage of assembly screws, by means of which the flat gasket forming the gasket plate 34 can be clamped between component sealing surfaces, and in order that the components forming these sealing surfaces can be drawn towards one another.

At least one of the gasket layers forming the gasket plate 34 is provided with a sealing bead 44, which encloses the entirety of the hot gas through-openings 36 and 38 completely and is closed within itself. Furthermore, at least one of the gasket layers forming the gasket plate 34 has in the region of the gasket plate web 40 at least one further sealing web 46, which extends in the longitudinal direction of the gasket plate web 40, may have two lengthwise ends spaced somewhat from the sealing bead 44 and is not interrupted between these lengthwise ends.

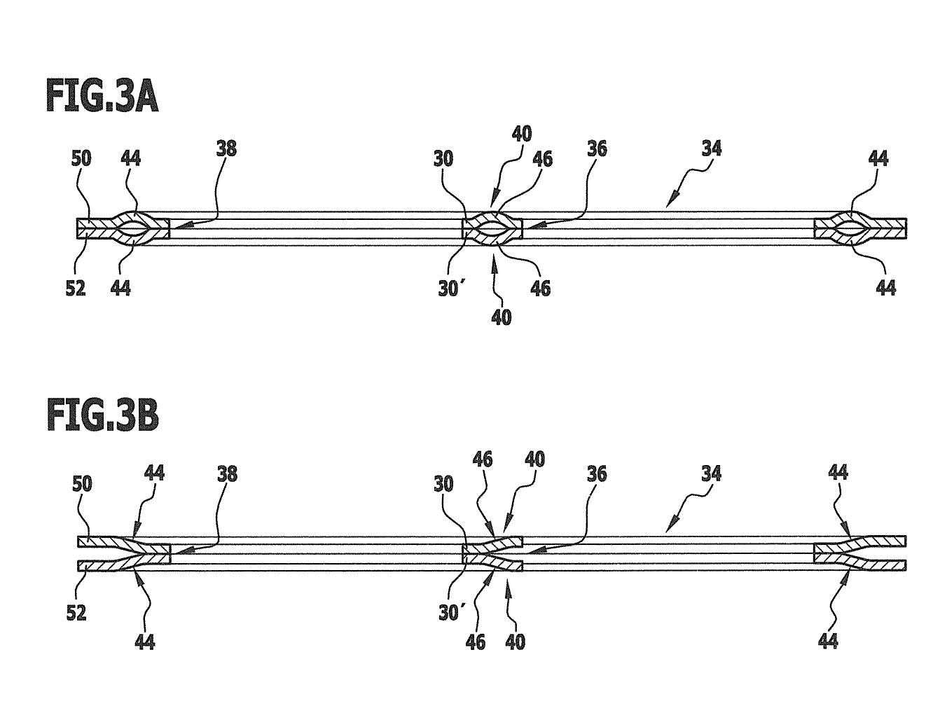

FIGS. 3A and 3B show sections taken along line 3-3 in FIG. 2 through two different, but similar and non-inventive embodiments of the flat gasket shown in FIG. 2. The same reference numerals were used in FIGS. 3A and 3B as in FIG. 2. FIGS. 3A and 3B do, however, show that the gasket plate 34 is formed by two gasket layers 50 and 52.

In the embodiment in accordance with FIG. 3A, all of the sealing beads 44 and 46 are formed by full beads, in the embodiment in accordance with FIG. 3B by half beads. Finally, for non-inventive embodiments mention is made of the fact that the gasket layer 50 has the same material thickness in all of its regions, and the same applies to the gasket layer 52, although the material thicknesses of the two gasket layers could be different. Consequently, the sum of the material thicknesses of the gasket layers 50 and 52 is then the same in all of the regions of the gasket plate 34, even if this sum of the material thicknesses in the flat gasket shown in FIG. 3B may be a different one than in the flat gasket in accordance with FIG. 3A.

By a modification of the flat gaskets shown in FIGS. 3A and 3B, these may now be configured in accordance with the invention: To do so, the material thickness of at least one of the gasket layers 50 and 52 is provided in the region of its gasket layer web 30 or 30′, respectively, with a reduced material thickness which is smaller than the material thickness of this gasket layer in other regions of this gasket layer bordering on the hot gas through-openings 36 and 38. From FIG. 1 and the above description thereof it will be clear that the pressing forces between the gasket plate web 40 (designated 28 in FIG. 1) and the component webs 26, 26′ clamping it can be reduced by this measure so as to at least almost eliminate the risk of permanent deformation of these component webs and/or damage to the gasket plate web 40.

Finally, it is pointed out, in view of the representation of the length and position of the sealing bead 46 in FIG. 2, that in the flat gasket shown in FIG. 3A, with the modification in accordance with the invention, the sealing beads 46 could open at their ends into the sealing beads 44 as all sealing beads are configured as full beads.

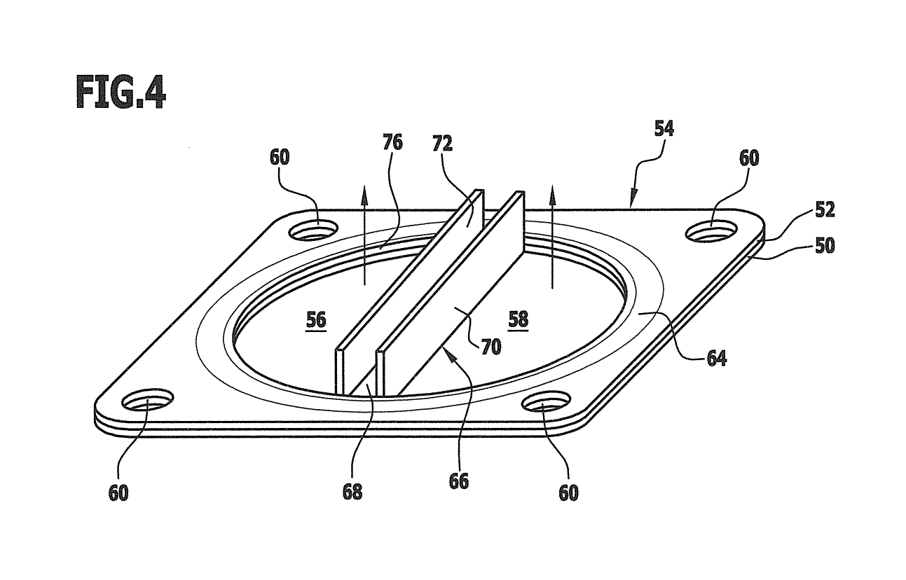

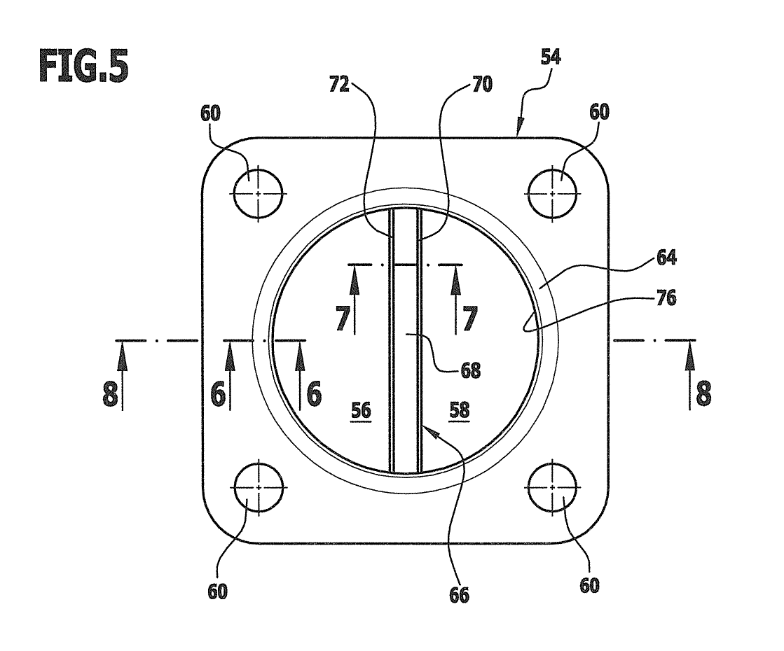

FIGS. 4 and 5 show a particularly advantageous embodiment of the configuration, in accordance with the invention, of a flat gasket in the region of two adjacent hot gas through-openings. In this connection, it is pointed out that the configuration of this flat gasket outside of these hot gas through-openings is not decisive for the basic concept underlying the present invention.

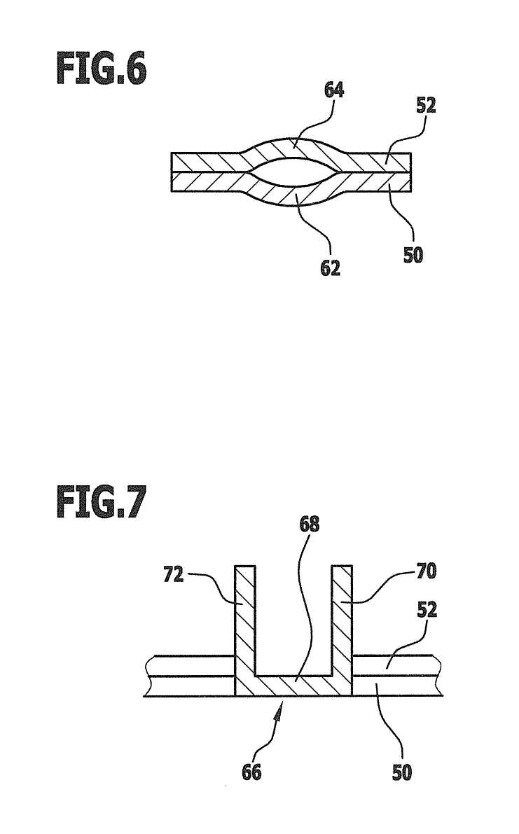

As indicated in FIGS. 4 to 7, this flat gasket has a gasket plate 54 formed by two gasket layers 50 and 52 with two hot gas through-openings 56 and 58 and screw holes 60 for the passage of assembly screws.

Each of the gasket layers 50, 52 is provided with an endless sealing bead 62 and 64, respectively, completely enclosing the entirety of the hot gas through-openings 56 and 58. These beads are configured as full beads and protrude in opposite directions beyond the two main surfaces of the gasket plate 54. These sealing beads could, however, also be configured as half beads. In general, it is only a question of the entirety of the two or all hot gas through-openings of a flat gasket being completely enclosed by at least one sealing element, in order to prevent hot gas from leaking from the sealing system.

In a plan view of the gasket plate 54, two adjacent hot gas through-openings, namely in the present case the openings 56 and 58, are separated from each other by a gasket plate web designated 66 in FIG. 5. In accordance with the invention, this gasket plate web is, however, only formed by a single gasket layer, namely by a gasket layer web 66 formed on the gasket layer 50. In the preferred embodiment shown in the drawings, the gasket layer web 66 has an approximately U-shaped cross section and is formed by a web base 68 preferably lying in the plane of the gasket layer 50 and by two web-like or rib-like gas blocking elements 70 and 72, which project upwards over the gasket layer 50 and also protrude beyond the upper main surface of the gasket plate 54. As will be explained in more detail hereinbelow, the approximately U-shaped cross section of the gasket layer web 66 preferably already has in the condition of the flat gasket at the time of delivery, i.e., when the flat gasket is not yet stressed, such a clear inner width, i.e., a transverse spacing between the gas blocking elements 70 and 72, that a component web corresponding to the component web 26 of the sealing system shown in FIG. 1 can, in accordance with FIG. 7, be pushed in from above between the gas blocking elements 70, 72 and pushed forwards as far as the web base 68, the latter possibly by widening the space between the gas blocking elements 70 and 72, with these, in accordance with FIG. 7, being, in particular, elastically deflected in the horizontal direction and away from each other and thereby being resiliently positioned against the component web. When the flat gasket is installed, the gas blocking elements 70 and 72 can, however, also accommodate a component web such as the component web 26 of the sealing system shown in FIG. 1 more or less loosely between them and do not have to lie sealingly against the side surfaces of the component web.

In a plan view of the gasket plate 54, the gas blocking elements 70 and 72 in the preferred embodiment extend as far as the edges of the hot gas through-openings 56 and 58.

Furthermore, in the preferred embodiment, the gas blocking elements 70 and 72 were formed from the gasket layer 50, for example, by making punched cuts in this gasket layer and subsequently bending the gas blocking elements out of the gasket layer 50.

In preferred embodiments, a gasket layer arranged on the gasket layer forming the gasket layer web, i.e., in the case represented in the drawings, the gasket layer 52, has in the region of the two hot gas through-openings 56 and 58 and the gasket layer web 66, only a single hot gas through-opening 76, the contour of which extends congruently with the contours of the hot gas through-openings 56 and 58 on either side of the gasket layer web 66, with the gas blocking elements 70 and 72 extending through the hot gas through-opening 76 from the bottom to the top.

In preferred embodiments of the flat gasket in accordance with the invention, at least one gasket layer provided with a sealing bead enclosing the entirety of the hot gas through-openings consists of a high-alloy spring steel which also maintains its spring-elastic properties at least to a considerable extent at the operating temperatures prevailing around a hot gas through-opening in the gasket plate. In this connection, it is pointed out that in a spring steel the ratio of the yield strength Rₑ or the elastic limit R_{p0.2} to the tensile strength Rₘ is greater than 0.85. In the flat gasket shown in FIGS. 4 to 7, the above, therefore, preferably applies to both gasket layers 50, 52.

If the flat gasket in accordance with the invention shown in FIGS. 4 to 7 is used in a sealing system in the way shown in FIG. 1, and the component web 26 engages the U-profile formed by the gasket layer web 66, the flat gasket only has a material thickness between the component webs 26 and 26′ corresponding to the material thickness of the gasket layer 50, whereas peripheral regions of the two components 10, 10′ include between them regions of the gasket plate 54 whose material thickness is equal to the sum of the material thicknesses of the gasket layers 50 and 52. As a result of this, the component webs 26 and 26′ can expand sufficiently in the axial direction when the sealing system is in operation, without these and/or the flat gasket becoming damaged.

Owing to the gas blocking elements 70 and 72 pointing upwards in accordance with FIG. 4, this flat gasket is recommended for sealing systems in which the flow through the hot gas through-openings 56, 58 is from the bottom to the top in accordance with FIG. 4.

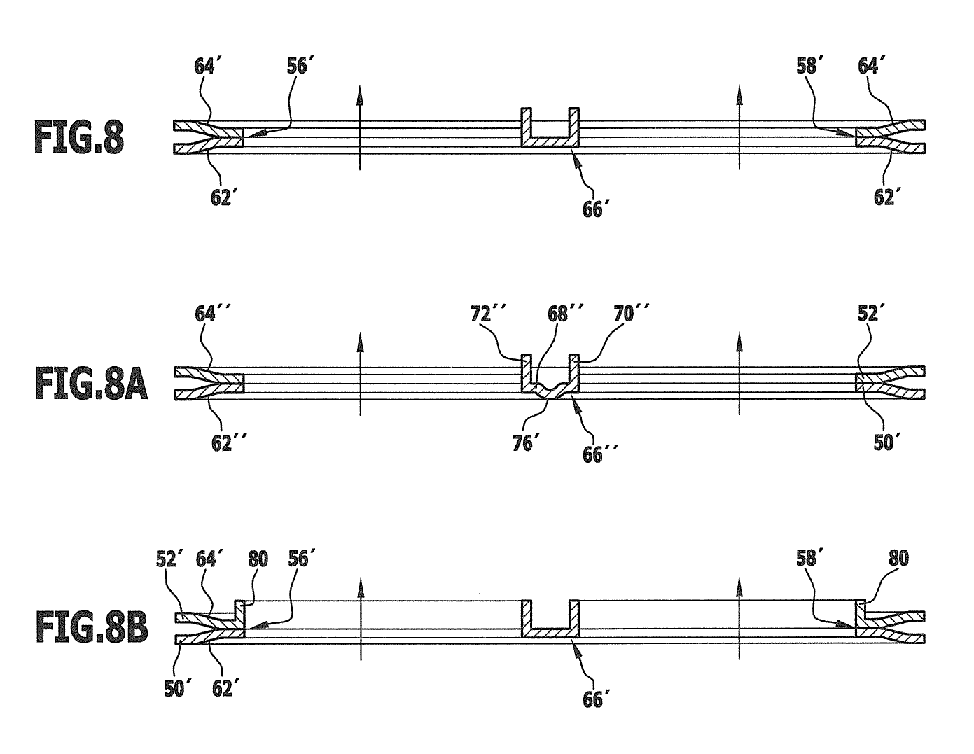

FIGS. 8 and 8A show modifications of the embodiment shown in FIG. 4. Therefore, in FIGS. 8 and 8A, as far as possible, the same reference numerals were used as in FIGS. 4 to 7, but with the addition of a prime or two primes, and in the following FIGS. 8 and 8A will only be described insofar as the flat gaskets represented therein deviate from the flat gasket in accordance with FIGS. 4 to 7.

In the flat gasket shown in FIG. 8, the sealing beads 62′ and 64′ are not configured as full beads, but as half beads. Otherwise there is conformity with the flat gasket in accordance with FIGS. 4 to 7.

The flat gasket in accordance with FIG. 8A differs from that in accordance with FIG. 8 in that there was embossed in the web base 68″ a bead 76′, which projects over the web base in a direction opposite to the projecting direction of the gas blocking elements 70″ and 72″ and, when the flat gasket is installed in accordance with FIG. 1, is to be pressed by the component web 26 against the end face of the component web 26′ so as to seal as well as possible. The bead 76′ is preferably a so-called microbead, the height and width of which are substantially smaller than the height and width of a conventional sealing bead such as sealing beads 44 and 46.

The flat gasket shown in FIG. 8B constitutes a further modification of the flat gasket in accordance with FIG. 8 and differs therefrom only by two elements described hereinbelow. The same reference numerals as in FIG. 8 were therefore used for the remaining elements in FIG. 8B. In the flat gasket in accordance with FIG. 8B, one of the gasket layers, namely, in this case, the gasket layer 52′, has around each of the hot gas through-openings 56′ and 58′, with the exception of the circumferential regions formed by the gasket layer web 66′, in each case, a rib-like or web-like gas blocking element and/or guide element, which will be referred to in the following as rib and has been designated as 80 in FIG. 8B. The collar-like ribs 80 have, in accordance with the invention, such a shape that when the flat gasket shown in FIG. 8B is installed in the sealing system shown in FIG. 1, the ribs 80 engage in one of the hot gas channels 18, in each case, and preferably lie against their inside wall surfaces, in particular, in a more or less well sealing manner.

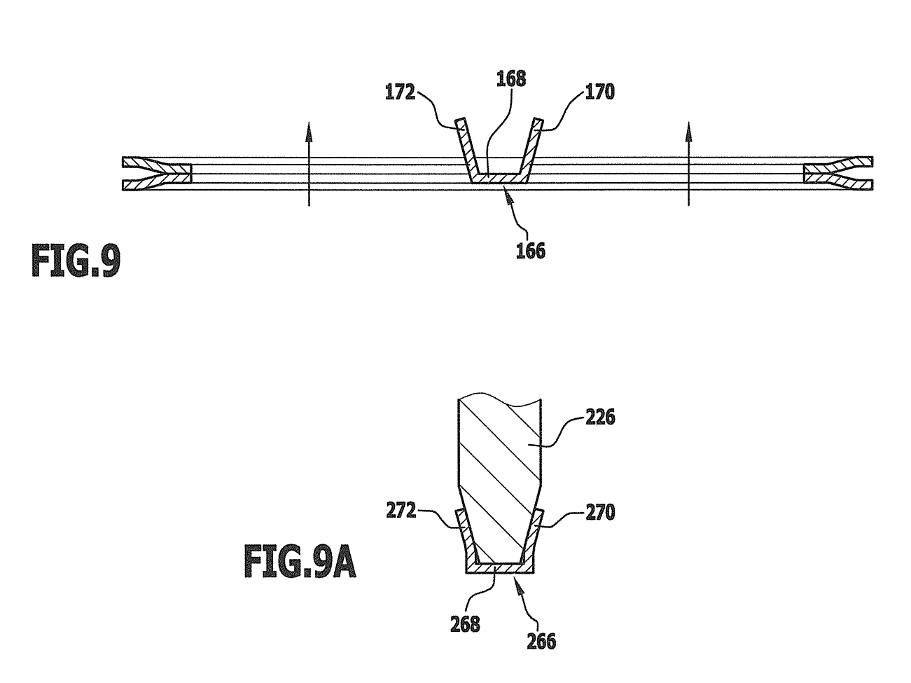

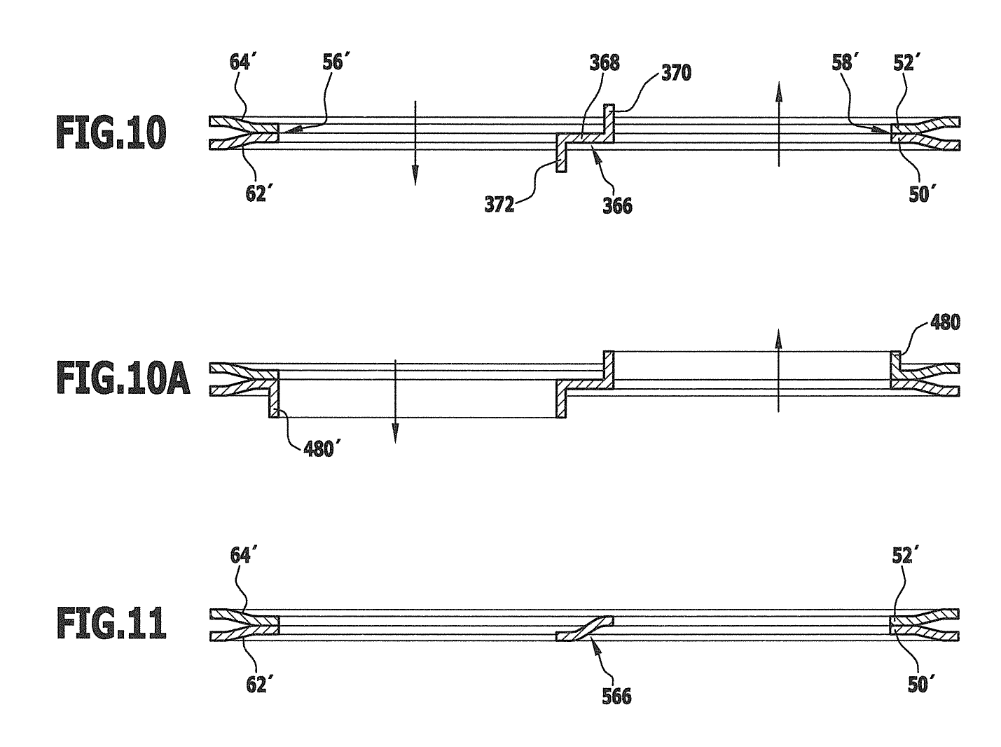

In FIGS. 4, 8, 8A and 8B, but also in the FIGS. 9, 10 and 10A still to be explained, the directions in which the flows of hot gas flow through the flat gasket (and in the installed state the hot gas channels 18, 18′) have been indicated by arrows.

In the flat gaskets in accordance with FIGS. 4, 8, 8A, 8B and 9, the flow through the hot gas through-openings of the respective flat gasket is in the same direction, namely from the bottom to the top in accordance with the Figures of the drawings. The gas blocking elements of the gasket layer webs 66 and 66′ and 66″, respectively, therefore protrude upwards beyond the gasket plate of the respective flat gasket, and the same applies to the ribs 80 of the flat gasket in accordance with FIG. 8B.

FIG. 9 shows a flat gasket in accordance with the invention, which differs from that in accordance with FIG. 8 only in the configuration of the gasket layer web. The gasket layer web 166 shown in FIG. 9 also has an approximately U-shaped cross section and has a web base 168 and two web-like gas blocking elements 170 and 172, which, however, even when the flat gasket is not yet stressed, do not extend approximately parallel to each other, but define with each other an acute angle opening upwardly in accordance with FIG. 9 and so when the flat gasket is installed in the sealing system shown in FIG. 1, a component web corresponding to its component web 26 can be introduced more easily between the gas blocking elements.

FIG. 9A shows a gasket layer web 266 again in section, and this gasket layer web can correspond to the gasket layer web 166 of the flat gasket in accordance with claim 9, but it preferably corresponds to the gasket layer web 66 shown in FIG. 7, i.e., before assembly of the flat gasket, the gasket layer web 266 has gas blocking elements 270 and 272 extending approximately parallel to each other, which, in the course of assembly of the sealing system, are preferably elastically deflected by a component web 226 lowered as far as a web base 268 and pressed against the web base 268, with the groove formed by the gasket layer web 266 widening upwards in accordance with FIG. 9A.

In accordance with the representation in FIG. 9A, a sealing system provided for a flat gasket in accordance with the invention is configured in accordance with the invention such that a component web (in the case of FIG. 9A the component web 226) to be introduced into a gasket layer web of approximately V-shaped or approximately U-shaped cross section has a cross sectional shape which tapers in the direction towards the end face of the component web, preferably by the two side flanks of the component web being slanted in the vicinity of the component web end face. In this way, too, introduction of the component web into the gasket layer web is facilitated.

FIGS. 10 and 10A show preferred embodiments of a flat gasket in accordance with the invention, in which the flows of hot gas through adjacent hot gas through-openings flow in opposite directions.

The flat gasket in accordance with FIG. 10 differs from that in accordance with FIG. 8 only in the configuration of the gasket layer web. Therefore, as far as possible, the same reference numerals as in FIG. 8 were used in FIG. 10, and only the gasket layer web shown in FIG. 10 will be explained in the following.

This gasket layer web 366 has an approximately Z-shaped cross section with a web base 368 from which, on its side facing the hot gas through-opening 58′, a rib-like or web-like gas blocking element 370 projects in the direction of flow of the flow of gas passing through the hot gas through-opening 58′, whereas on the other longitudinal side of the web base 368 a gas blocking element 372 is provided, which projects from the web base in the opposite direction, namely in the flow-through direction of the hot gas through-opening 56′.

Since the flat gasket in accordance with the invention shown in FIG. 10A conforms with that in accordance with FIG. 10 except for two elements which correspond to the ribs 80 of the embodiment in accordance with FIG. 8B, it need only be pointed out in connection with the flat gasket in accordance with FIG. 10A that these two elements are the ribs 480 and 480′ shown in FIG. 10A, which, in each case, project in the flow-through direction of the hot gas through-opening adjacent to the respective rib.

The further preferred embodiment of the flat gasket in accordance with the invention shown in FIG. 11 also corresponds to the flat gasket in accordance with FIG. 8 except for the configuration of its gasket layer web and only serves the purpose of explaining a further variant of the basic concept underlying the present invention on the basis of the flat gasket in accordance with FIG. 11. Therefore, as far as possible, the same reference numerals were used in FIG. 11 as in FIG. 8.

In accordance with FIG. 11, this variant of the flat gasket in accordance with the invention comprises a gasket layer web 566 which, in this variant, is formed by the lower gasket layer 50′, but could also be formed by the upper gasket layer 52′. In each case, the respective other gasket layer has no web in the region of this gasket layer web.

The gasket layer web 566 has a cross-sectional shape similar to a Z (or S) drawn flat, and, in accordance with the invention, the width of this cross-sectional shape is at least approximately equal to the width of the cross sections of the end faces of the two component webs between which the gasket layer web 566 is clamped when the flat gasket is installed, these component webs corresponding to the component webs 26 and 26′ of the sealing system shown in FIG. 1.

In the flat gasket in accordance with FIG. 11, the flow-through direction of the two hot gas through-openings of the flat gasket adjacent to the gasket layer web 566 is irrelevant.

The following is to be noted in connection with the flat gasket in accordance with the invention and, therefore, in connection with all of the embodiments shown in the Figures of the drawings.

The gasket layers of the flat gasket can be connected to one another in any known way, for example, by spot welding.

All gasket layers may be so-called functional layers (a functional layer typically has one or more beads, in particular, sealing beads). One of the gasket layers may, however, be a sheet-metal carrier plate, i.e., a so-called carrier layer, or a so-called stopper layer, the sheet metal thickness/material thickness of a carrier layer or a stopper layer usually being significantly greater than the sheet metal thickness/material thickness of a functional layer.

In a flat gasket in accordance with the invention, a functional layer or the functional layers preferably has or have a sheet metal thickness ranging between approximately 0.25 mm and approximately 0.3 mm. The height of a rib-like or web-like gas blocking element or of the rib-like or web-like gas blocking elements is then from approximately 3 mm to approximately 4 mm.

The sealing bead enclosing the entirety of the hot gas through-openings preferably has a width of from approximately 1.5 mm to approximately 3 mm and, in particular, a width of approximately 2 mm.

Finally, in preferred embodiments of the flat gasket in accordance with the invention, the width of the cross section of a gasket plate web or a gasket layer web is from approximately 2 mm to approximately 4 mm, in particular, from approximately 2.5 mm to approximately 3.5 mm.

If the present invention is implemented by means of a gasket layer web of reduced thickness, preferably on a gasket layer with a material thickness/sheet metal thickness in the range of a few tenths of a millimeter (typically approximately 0.2 to approximately 0.3 mm), the sheet metal thickness in the region of the gasket layer web is preferably reduced by a few hundredths of a millimeter (typically by approximately 0.05 mm). Also, it may be advantageous to provide the gasket layer web with a topographically configured surface by embossing.

The following is to be noted in connection with the present invention: Above all, metallic flat gaskets to be installed in the exhaust gas region of an internal combustion engine are designed by the gasket design engineer for the respective installation site, which, in particular, is the sealing gap between a cylinder head and an exhaust manifold or the sealing gap between a connection flange of an exhaust gas turbocharger and a component on which the exhaust gas turbocharger is installed. The data such as dimensions and materials of the components accommodating the flat gasket between them and their operating temperatures are known to the gasket design engineer and so, in particular, with an FEM calculation he is able to determine the thermal expansions which, during operation, occur in the component webs, between which the at least one gasket plate web of the flat gasket is arranged when the flat gasket is installed. Consequently, the design engineer of a flat gasket in accordance with the invention is fully capable of determining the sum of the material thicknesses of the gasket layers in the region of a gasket plate web such that during operation the pressing forces acting on the gasket plate web do not lead to adverse effects, in connection with which reference is made to the statements made at the outset.

1. A metallic flat gasket for installation between sealing surfaces, which face each other, of components conducting hot gas, which are connected to one another, said metallic flat gasket comprising a gasket plate which is compressed when the gasket is installed and which has at least two metallic gasket layers arranged one above the other and several hot gas through-openings, said gasket plate having between at least two adjacent hot gas through-openings a gasket plate web which separates the hot gas through-openings from one another;
wherein the sum of the material thicknesses of the gasket layers in the region of a gasket plate web is less than in other gasket plate regions bordering on the hot gas through-openings, and in that the gasket plate also has in the region of this gasket plate web at least one gasket layer.

2. The flat gasket in accordance with claim 1, wherein at least a first one of the gasket layers comprises in the region of at least one gasket plate web a gasket layer web which, in a plan view of the gasket plate, separates the two hot gas through-openings adjacent to the gasket plate web from each other.

3. The flat gasket in accordance with claim 2, wherein the gasket layer web is provided with at least one elongate gas blocking element extending in the longitudinal direction of the gasket layer web and protruding beyond the first gasket layer.

4. The flat gasket in accordance with claim 3, characterized in that the gas blocking element projects over at least one of the two main surfaces of the gasket plate.

5. The flat gasket in accordance with claim 3, wherein the gasket layer web has a substantially L-shaped, V-shaped, U-shaped or Z-shaped cross section in the region of the gas blocking element.

6. The flat gasket in accordance with claim 5, wherein when the flat gasket is installed, the at least one gas blocking element is deflected and pretensioned transversely to its longitudinal direction.

7. The flat gasket in accordance with claim 2, wherein at least one gasket layer has such a varying material thickness that this gasket layer has in the region of at least one gasket layer web formed by it a material thickness which is smaller than the material thickness in other regions of this gasket layer bordering on the hot gas through-openings.

8. The flat gasket in accordance with claim 7, characterized in that in the gasket layer with varying material thickness, all of the gasket layer webs have a smaller material thickness than other regions of this gasket layer bordering on the hot gas through-openings.

9. The flat gasket in accordance with claim 7, wherein the gasket layer web of reduced thickness is provided with at least one gas blocking element in the form of an elongate bead extending in the longitudinal direction of the gasket layer web.

10. The flat gasket in accordance with claim 2, wherein at least one second gasket layer has no web in the region of a gasket plate web.

11. The flat gasket in accordance with claim 10, wherein the gasket layer having no web has no web in the regions of all gasket plate webs.

12. The flat gasket in accordance with claim 1, which is configured such that the reduction in some regions in the sum of the material thicknesses of the gasket layers is only brought about by a single gasket layer.

13. The flat gasket in accordance with claim 1, wherein at least one of the gasket layers is provided with a sealing bead which, in a plan view of the gasket plate, completely encloses the entirety of the hot gas through-openings.

14. The flat gasket in accordance with claim 13, wherein the gasket layer web is provided with at least one elongate gas blocking element extending in the longitudinal direction of the gasket layer web and protruding beyond the first gasket layer, and in that the gas blocking element has lengthwise ends spaced from the sealing bead.

15. The flat gasket in accordance with claim 1, wherein the gasket is constructed as a gasket configured for the exhaust gas region of an internal combustion engine.

16. The flat gasket in accordance with claim 15, wherein the gasket is configured as a flange gasket for installation on an exhaust gas turbocharger.

17. A sealing system with a metallic flat gasket, which is clamped between sealing surfaces, which face each other, of components which are connected to one another, each of said components containing at least two hot gas channels which extend adjacently to each other and open into its component sealing surface, and between which there is provided in the component a separating wall separating the hot gas channels from each other and forming a component web ending at the component sealing surface, said flat gasket comprising a gasket plate with at least two metallic gasket layers arranged one above the other and several hot gas through-openings via which the hot gas channels of the components communicate with one another, and said gasket plate having between at least two adjacent hot gas through-openings a gasket plate web which separates the hot gas through-openings from one another and is arranged between two component webs of the components accommodating the flat gasket between them, characterized in that the sum of the material thicknesses of the gasket layers in the region of a gasket plate web is less than in other gasket plate regions bordering on the hot gas through-openings, and in that the gasket plate also has in the region of this gasket plate web at least one gasket layer.

18. The sealing system in accordance with claim 17, wherein the flat gasket comprises a gasket plate which is compressed when the gasket is installed and which has at least two metallic gasket layers arranged one above the other and several hot gas through-openings, said gasket plate having between at least two adjacent hot gas through-openings a gasket plate web which separates the hot gas through-openings from one another;
wherein the sum of the material thicknesses of the gasket layers in the region of a gasket plate web is less than in other gasket plate regions bordering on the hot gas through-openings, and in that the gasket plate also has in the region of this gasket plate web at least one gasket layer; and
wherein at least a first one of the gasket layers comprises in the region of at least one gasket plate web a gasket layer web which, in a plan view of the gasket plate, separates the two hot gas through-openings adjacent to the gasket plate web from each other.

19. The sealing system in accordance with claim 17, wherein the flat gasket comprises a gasket plate which is compressed when the gasket is installed and which has at least two metallic gasket layers arranged one above the other and several hot gas through-openings, said gasket plate having between at least two adjacent hot gas through-openings a gasket plate web which separates the hot gas through-openings from one another;
wherein the sum of the material thicknesses of the gasket layers in the region of a gasket plate web is less than in other gasket plate regions bordering on the hot gas through-openings, and in that the gasket plate also has in the region of this gasket plate web at least one gasket layer;
wherein at least a first one of the gasket layers comprises in the region of at least one gasket plate web a gasket layer web which, in a plan view of the gasket plate, separates the two hot gas through-openings adjacent to the gasket plate web from each other;
wherein the gasket layer web is provided with at least one elongate gas blocking element extending in the longitudinal direction of the gasket layer web and protruding beyond the first gasket layer;
wherein the gasket layer web has a substantially L-shaped, V-shaped, U-shaped or Z-shaped cross section in the region of the gas blocking element; and
wherein the component web associated with the gasket layer web of substantially V-shaped or U-shaped cross section, lying on the open side of the gasket layer web and having an end face facing the gasket layer web has a cross section transverse to the longitudinal direction of the component web, which tapers in the direction towards the component sealing surface such that the end face of the component web lies against the base of the V-shaped or U-shaped cross section of the gasket layer web.
